(19) United States
(12) Patent Application Publication
(10) Pub. No.: US 2020/0317114 A1
(43) Pub. Date: Oct. 8, 2020

(54) AGRICULTURAL WORKING MACHINE

(71) Applicant: CLAAS E-Systems GmbH, Dissen a.T.W. (DE)

(72) Inventor: Carsten Hoff, Rheda-Wiedenbrück (DE)

(73) Assignee: CLAAS E-Systems GmbH, Dissen a.T.W. (DE)

(21) Appl. No.: 16/828,248

(22) Filed: Mar. 24, 2020

(30) Foreign Application Priority Data
Apr. 2, 2019 (DE) DE 102019108505.5

(51) Int. Cl. B60Q 1/08; B60Q 1/00; A01D 41/127

(52) U.S. Cl. CPC B60Q 1/085; B60Q 1/0076; B60Q 2300/45; B60Q 2300/32; A01D 41/127

(57) ABSTRACT

An agricultural working machine including at least one optical sensor apparatus, an image processing system, a work lighting system that includes one or more light sources, and a regulation and control device configured to control the work lighting system is disclosed. The image processing system, using the optical sensor apparatus, detects the occurrence of one or more obstacles in an obstacle region in the forefield of the agricultural working machine. The regulation and control device generates control signals that control orientation the one or more light sources in order to orient light beam(s) generated by the one or more lights sources toward the obstacle region.

### CROSS REFERENCE TO RELATED APPLICATION

This application claims priority under 35 U.S.C. § 119 to German Patent Application No. DE 102019108505.5 (filed Apr. 2, 2019), the entire disclosure of which is hereby incorporated by reference herein.

### TECHNICAL FIELD

The present invention relates to an agricultural harvesting machine (such as a self-propelling harvesting machine or tractor) and a method for operating an agricultural harvesting machine.

### BACKGROUND

The detection of obstacles that are in a crop is important to the operator of an agricultural working machine in order to prevent injury to living beings, such as persons and animals. Likewise, detecting obstacles (e.g., a rock, etc.) may prevent damage to the agricultural working machine and an attachment arranged or positioned on the front of said agricultural working machine.

DE 10 2011 119 9263 A1 discloses projecting a recognized obstacle in the form of a warning at a target position at a distance from the operator of the vehicle along a route lying in front of the vehicle. EP 2 158 799 B9 controls a work lighting system of an agricultural working machine using a regulating and control apparatus while detouring around a recognized obstacle so as to illuminate the obstacle over the duration of the detour.

### DESCRIPTION OF THE FIGURES

The present application is further described in the detailed description which follows, in reference to the noted plurality of drawings by way of non-limiting examples of exemplary implementation, in which like reference numerals represent similar parts throughout the several views of the drawings, and wherein:

FIG. 1 shows a schematic representation of an agricultural working machine and an image operating system; and

FIG. 2 shows a schematic representation of the agricultural working machine in a plan view while processing a field.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

An agricultural working machine is disclosed that makes an operator of the agricultural working machine aware early on and clearly of existing obstacle(s) and their particular position in the forefield.

In one or some embodiments, an agricultural working machine is disclosed that comprises: at least one optical sensor apparatus; an image processing system; and a regulation and control device that is configured to control a work lighting system, which may comprise one or more (such as a plurality) of light sources. The at least one optical sensor apparatus is positioned and configured to detect a surrounding area in the forefield of the agricultural working machine. The image processing system is configured to detect the occurrence of one or more obstacles in at least one obstacle region lying or positioned in the surrounding area in the forefield of the agricultural working machine using image analysis. The regulation and control device is configured to generate control signals that control an orientation of at least one light source assigned to the agricultural working machine that is configured to generate at least one bundled light beam comprising (or consisting of) visible light and/or invisible light in order to orient the at least one light beam toward the identified obstacle region. By the targeted orienting of the light beam emitted by the at least one light source assigned to the agricultural working machine, the attention of the operator is oriented directly and clearly toward the identified obstacle region. In this way, the targeted illumination of the obstacle region stimulates or heightens the attention of the operator and directs the attention toward the obstacle, independent of whether or not the obstacle is directly visible to the operator of the agricultural working machine. For example, in the event of a rock or a crouching fawn covered by vegetation, the operator may be unable to perceive or recognize the obstacle as such, or to perceive or recognize the obstacle in due time. Instead, orienting the at least one light beam toward the obstacle region may clearly identify the position of the obstacle region in the forefield of the agricultural working machine, thus being clearly discernable by the operator. This is particularly helpful for the operator of the agricultural working machine when doing fieldwork in the dark or under difficult or low light conditions, which may further hinder the operator being able to keep track of the surrounding area (e.g., the region around the agricultural working machine that may be seen from a driver's cabin by the operator). The orientation of the at least one light beam and/or the at least one light source may vary in one of several ways. As one example, the at least one light beam and/or the at least one light source may swing using an actuator around a vertical and/or a horizontal axis. In one or some embodiments, the actuator may be controlled by the regulation and control device.

In so doing, the regulation and control device may be configured to track the orientation of the emitted light beam of the at least one light source when the agricultural working machine approaches the obstacle region (e.g., the regulation and control device may dynamically modify the orientation of the emitted light beam based on the position of the agricultural working machine relative to the detected obstacle). Alternatively, or in addition, the regulation and control device may modify at least one aspect of the emitted light beam as the agricultural working machine approaches the obstacle region (e.g., narrowing or reducing the width of the beam from a larger size to a selected width (which may be based on a size(s) of the detected obstacle(s)) as the agricultural working machine approaches the one or more obstacles detected). This ensures or improves the likelihood that the obstacle region will remain permanently or sufficiently illuminated until the agricultural working machine has passed the obstacle region.

In particular, in one or some embodiments, the image processing system may be configured to differentiate between different types of obstacles. Various types of obstacles are contemplated. For example, in addition to obstacles that project above the vegetation, there may be obstacles that can be covered thereby. Moreover, daylight and predominating light conditions may have a major influence on the identification of obstacles. Types of obstacles may, for example, be tools, attachments, other working machines or transportation vehicles or transport wagons that are identifiable as such due to their generally symmetrical contour. In contrast, for example, rocks, foundations of power poles, animals or people may form another type of obstacle for identification. Other types of obstacles are contemplated. In one or some embodiments, the image processing system may be configured to determine one or more aspects of the obstacle (such as dimensions of the obstacle). In this way, control of the light beam may be determined based on the determined one or more aspects (e.g., the size of an obstacle region may be deduced, such as based on the dimensions of the obstacle, toward which the at least one light beam may be directed).

In one or some embodiments, the image processing system may be configured to differentiate between different types of objects, such as between living and inanimate obstacles. In this manner, the regulation and control device may perform a weighting in order to decide which obstacle region should preferably be illuminated, such as when, for example, several obstacles have been identified in the surrounding area that are close in space to each other. In one or some embodiments, responsive to identifying a living obstacle (such as a person or animal) and to identifying an inanimate obstacle (such as a rock), the regulation and control device may decide to illuminate more and/or to illuminate differently (e.g., different colors and/or different patterns, such as alternating between colors versus not alternating between different colors, alternating between different colors, strobing versus not strobing, or strobing at different frequencies) the sub-region associated with the location of the living obstacle and decide to illuminate less and/or differently the sub-region associated with the location of the inanimate obstacle.

In so doing, the regulation and control device may be configured to control the at least one light source in order to change at least one parameter of the at least one emitted light beam depending on the identified obstacle. Thus, depending on whether the obstacle is living or inanimate, the at least one parameter of the at least one emitted light beam may be changed in order to provide notification of a hazardous situation in which a living obstacle is involved.

In particular, the regulation and control device may control one or more changeable parameters of the at least one light source, such as the light color and/or light intensity. Accordingly, in one or some embodiments, different colors may be used by which to illuminate the identified obstacle region depending on the type of obstacle and/or whether the obstacle is living or inanimate. Alternatively, or in addition, the light intensity may be varied depending on the type of the obstacle. Moreover, a cyclical color change (e.g., controlling the at least one light source in order to vary the color generated to alternate between a first color and a second color, with the second color being different from the first color) of the at least one emitted light beam may also be generated in order to notify the operator of a special situation that may thereby result from the identified obstacle. In this regard, a first identified obstacle (such as a living obstacle) may be highlighted by controlling the at least one light source to alternate color output and a second identified obstacle (such as an inanimate object) may be highlighted by controlling the at least one light source to generate a single color output (or to alternate color output differently).

Alternatively, or in addition, the frequency may be adapted as the changeable parameter with which the at least one light source emits a light beam. In this case, the particular identified obstacle region may be illuminated intermittently. The attention of the operator may thereby be specifically directed toward the identified obstacle since there is lighting that differs from permanent lighting. As one example, a first identified obstacle (such as a living obstacle) may be highlighted by controlling the frequency of output of the at least one light source (e.g., strobing) and a second identified obstacle (such as an inanimate object) may be highlighted by controlling the at least one light source to generate a constant light output (or to generate output at a different frequency).

In one or some embodiments, the regulation and control device may be configured to control the at least one light source in order to adapt the light propagation of the light beam emitted by the at least one light source. In this case, the in particular divergent light propagation that basically appears as a conical light beam or light bundle with a cross-section that increases as the distance from the light source increases can be varied by controlling the at least one light source. As discussed above, various aspects of the light source may be modified. As one example, the width or narrowness of the emitted light beam may be changed responsive to identifying an obstacle (or responsive to identifying a particular type of obstacle). For example, the emitted light beam may be focused while increasingly approaching the obstacle or the obstacle region. In so doing, the focusing of the light beam or the light bundle may be limited to the size of the obstacle or the obstacle region ascertained by the image processing system, to the extent that this is recommendable. In this regard, the width/narrowness of the beam may be dependent on at least one aspect identified in the obstacle, such as the size of the obstacle. Thus, control of one or more aspects of the light source (such as the narrowness of the light beam generated by the light source) may achieve targeted orientation and/or focusing on the obstacle or the obstacle region. This is in contrast to enlarging the light propagation in order to illuminate an obstacle, which may reduce the likelihood that the operator may recognize the obstacle in the path of the agricultural working machine.

In a particular embodiment in which multiple objects are detected in the obstacle region, the regulation and control device may be configured to control at least two light sources in order to adapt the light propagation of the respective light beams emitted by the at least two light sources. Further, responsive to detecting different types of obstacles (e.g., a living obstacle versus an inanimate obstacle), the regulation and control device may be configured to control the at least two light sources in order to differentiate the respective beams generated (e.g., the regulation and control device may control at least one parameter (e.g., any one, any combination, or all of: intensity; color; frequency; width; etc.) of a first beam from the first light source (used to light the living obstacle) and a second beam of the second light source (used to light the inanimate obstacle) so that the first beam lights the living obstacle at least partly simultaneously as the second beam lights the inanimate obstacle and so that the first beam lights the living obstacle differently than the second beam lights the inanimate obstacle).

In one or some embodiments, the at least one optical sensor apparatus may be configured to detect the surrounding area in the forefield with light in the non-visible range (e.g., at least partly (or entirely) outside of the light spectrum of the visible range). This allows, inter alia, living obstacles that do not extend above the vegetation to be identified.

To accomplish this, the at least one optical sensor apparatus may be designed as a laser scanner, lidar sensor, radar sensor or camera. In particular, the camera may be designed as a video camera, infrared camera, monochrome camera, color camera or 3D camera. This allows the current surrounding area images to always be available for the image processing system. In particular with a color camera, information is available on the intensity and a color. Moreover, one or more optical sensor apparatuses may be used. For example, a larger range of the surrounding area may be covered by using several optical sensor apparatuses. By using radar sensors and/or laser scanners, image data may be expanded that, for example, are generated by camera images. Accordingly, distance measurements may, for example, be available based on signal runtimes and/or image data on shaded/covered anomalies. In particular, one or more aspects of the obstacles, such as dimensions, (e.g., height of the obstacle) may be easily ascertained by laser scanners and/or radar sensors.

In one or some embodiments, the at least one light source may be arranged or positioned on the agricultural working machine and/or on the front of an attachment accommodated by or connected to the agricultural working machine. In one or some embodiments, the arrangement or positioning of the at least one light source on the agricultural working machine may be on the roof of a driver's cab that generally forms the highest point of the agricultural working machine. In particular, a position in the outer edge region of the cab roof, viewed in the direction of travel, may comprise a widest possible surrounding area along the direction of travel and transverse thereto can be illuminated by the at least one light source.

Moreover, the at least one optical sensor apparatus may be arranged on the agricultural working machine and/or on the front of an attachment accommodated by or connected to the agricultural working machine.

In one or some embodiments, the regulation and control device may be configured to control the orientation of the at least two lights sources in order to focus the respective beams generated by the at least two lights sources on an identified obstacle region. In particular, two light beams may accordingly each be oriented toward an identified obstacle region (by adjusting the orientation of the two light sources respectively generating the two light beams) in order to achieve improved illumination. Moreover, this focusing of the light beams from at least two light sources may also be used to specially point out an identified living obstacle. As one example, responsive to the regulation and control device identifying a living obstacle, the regulation and control device may control the at least two light sources to both be directed to the location of the identified living obstacle. This may be in contrast to the regulation and control device identifying an inanimate obstacle and responsive thereto only directing one of the at least two light sources to the location of the identified inanimate obstacle.

In particular, the agricultural working machine may be designed as a self-propelling harvesting machine or as a tractor. The self-propelling harvesting machine may comprise a combine or a field harvester that is equipped with an attachment. This allows the scope of use of the agricultural working machine to be adapted to existing harvest requirements, such as the crop type, etc.

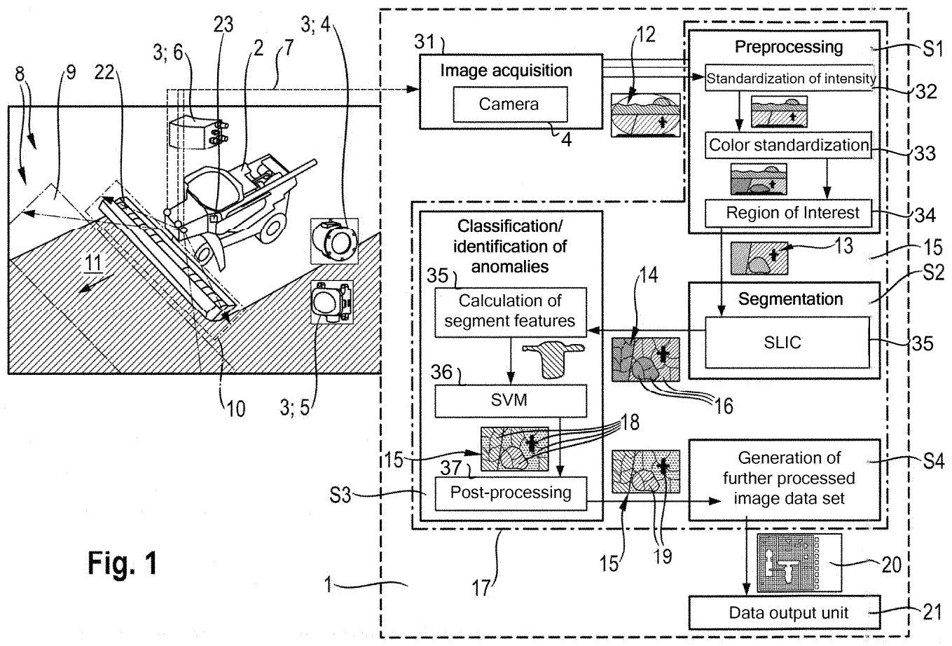

Referring to the figures, FIG. 1 schematically shows an agricultural working machine 2, that is known per se and will not be described further, with an image processing system 1. An example of an agricultural working machine is disclosed in US Patent Application Publication No. 2018/0177133 A1, incorporated by reference herein in its entirety. The agricultural working machine 2 comprises the image processing system 1, a regulation and control device 23, a data output unit 21 and at least one image generating system 3. In this case, the image processing system 1 is configured to process a selection of surrounding area images 7 recorded by the image generating system 3 in an image analysis unit 17. In one or some embodiments, the image analysis unit 17 is designed as a computing unit, which may include a processor 28 and a memory 29, discussed below. The image generating system 3 is configured to generate surrounding area images 7 and to transmit the processed surrounding area images 7 to the image processing system 1. Receiving from image acquisition 31 (using camera 4), the image processing system 1 is configured to preprocess the transmitted surrounding area images 12 in a first step S1, in particular surrounding area images 13 to be preprocessed (e.g., via any one, any combination, or all of: standardization of intensity 32, color standardization 33, and identification of region(s) of interest 34), to segment the preprocessed surrounding area images 13 in another step S2 (such as by simple linear iterative clustering (SLIC) 35 or another type of superpixel algorithm) so that segmented surrounding area images 14 arise, to classify arising segments 16 in a next step S3 (classification/identification of anomalies) so that obstacles 19 can be identified (e.g., as shown in FIG. 1, the image analysis unit 17 is configured to perform classification/identification of anomalies by any one, any combination, or all of: calculation of segment features 36; using a support vector machine (SVM) 37, a post processing 38) and, in a following step S4, to generate an image data set 20 that can be processed further. In one or some embodiments, transmitted surrounding area images 12, in particular their image characteristics, may be standardized in the first step S1. Preferably, a section of each transmitted surrounding area image 12 is also selected to be evaluated. During classification, segmented surrounding area images 14 become classified surrounding area images 15. Preferably, the obstacles 19 are identified during classification. Alternatively, the obstacles 19 are identified at a different location, for example by the regulation and control device 23 of the agricultural working machine 2. In one or some embodiments, the regulation and control device 23 may be configured to control the agricultural working machine 2 using the further processed image data set 20. In a specific embodiment, the regulation and control device 23 controls the agricultural working machine 2 autonomously or semi-autonomously.

The agricultural working machine 2 may be designed as a self-propelled combine, a self-propelled field harvester, or as a tractor. One or more attachments 22 can be arranged on or connected to the agricultural working machine 2. In this case, for example, the agricultural working machine 2 is designed as a combine with a cutting unit as an attachment 22. Moreover, the image generating system 3 may be arranged or positioned on the agricultural working machine 2.

The image generating system 3 comprises at least one optical sensor apparatus 24. In one or some embodiments, the optical sensor apparatus 24 may be designed as at least one camera 4. The camera 4 may comprise a monochrome camera, an infrared camera and/or a color camera. Alternatively or in addition, the image generating system 3 may comprise at least one optical sensor apparatus 24 designed as a radar sensor 5, lidar sensor or laser scanner 6. In one or some embodiments, other optical sensors or any number of optical sensors may be used. In particular, the camera 4 generates surrounding area images 7 of a surrounding area 8 of the agricultural working machine 2.

The surrounding area images 7 record a surrounding area 8 of the agricultural working machine 2. In one or some embodiments, the surrounding area 8 comprises a surrounding area of the agricultural working machine 2 and/or regions of the agricultural working machine 2 itself.

In one or some embodiments, the surrounding area is a forefield 9 of the agricultural working machine 2. The forefield 9 may extend in the driving direction 11 in front of the agricultural working machine 2, such as at least over a width corresponding to a width of the attachment 22. The surrounding area 8 may also comprise regions of the agricultural working machine 2 itself. In particular, the regions of the agricultural working machine 2 may comprise a region 10 of the attachment 22.

With regard to other details relating to the procedure for identifying obstacles 19 using the image processing system 1, reference is made to the subject matter disclosed in DE 10 2016 118 237 A1, incorporated by reference herein in its entirety.

An obstacle 19 identified by the image processing system 1 may be living or inanimate. A living obstacle 19 may comprise a person or an animal that is detected in the surrounding area 8 detectable in the forefield 9 by a sensor. An inanimate obstacle 19 may comprise a rock, a foundation of a power pole, a tool, an attachment, another working machine, a transport vehicle, or a transport wagon. Using the image processing system 1, the different types of obstacles 19 may be identified as well as their particular location in the forefield 9.

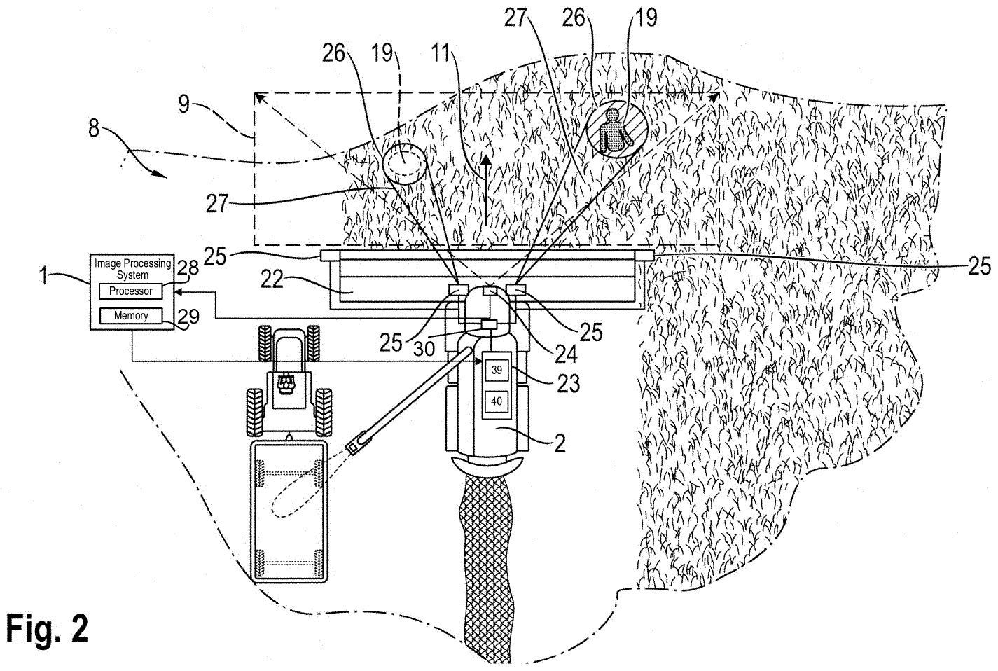

FIG. 2 shows a schematic representation of the agricultural working machine 2 in a plan view while processing a field. A plurality of light sources 25 are arranged or positioned on the agricultural working machine 2 that are part of a work lighting system of the agricultural working machine 2 (with light sources 25 shown positioned at one or more sections of the agricultural working machine 2) to illuminate the surrounding area 8, the forefield 9, as well as the region 10 of the attachment 22. As shown in FIG. 2, the light sources 25 are arranged on the cab roof of a driver's cab of the agricultural working machine 2. The work lighting system is controlled inter alia to start it up by the regulation and control device 23. Light sources of the work lighting system are generally arranged at different locations of the agricultural working machine 2. In one or some embodiments, the other light sources 25 of the work lighting system may be arranged or positioned, inter alia, in the region of the driver's cab of the agricultural working machine 2. Depending on the design of the agricultural working machine 2, parts of the work lighting system may also be arranged or positioned at other locations of the agricultural working machine 2.

The representation in FIG. 2 illustrates the interaction of the image processing system 1 and the regulation and control device 23 that controls the orientation of light beams 27 that are emitted by the light sources 25. The part of the surrounding area 8 in the forefield 9 of the agricultural working machine 2 is detected looking ahead by the at least one optical sensor apparatus 24.

The image processing system 1 may comprise any type of computing functionality and may include processor 28 and memory 29. Likewise, the regulation and control device 23 may comprise any type of computing functionality and may include processor 39 and memory 40. In this regard, any discussion regarding computing functionality for the image processing system 1 may likewise be applied to the regulation and control device 23. Further, in one embodiment, the computing functionality for the image processing system 1 is separate from the computing functionality for the regulation and control device 23. Alternatively, the computing functionality for the image processing system 1 may be integrated with the computing functionality for the regulation and control device 23 (e.g., same processor/memory used in both the image processing system and the regulation and control device 23).

Though processor 28, 39 (which may comprise a microprocessor, controller, PLA or the like) and memory 29, 40 are depicted as separate elements, they may be part of a single machine, which includes a microprocessor (or other type of controller) and a memory unit. The microprocessor and memory unit are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions, which may comprise computer-readable instructions, may implement the functionality described herein and may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described herein or illustrated in the drawings.

The image processing system 1 is configured to detect the occurrence of one or more obstacles 19 using image analysis of at least one obstacle region 26 lying in the forefield 9 of the agricultural working machine 2. The image processing system 1 may determine one or more aspects of the detected obstacle. In one or some embodiments, the image processing system 1 is configured to determine at least the position and the type of obstacle 19 in the obstacle regions 26 and to transmit the position and the type of obstacle 19 to the regulation and control device 23. In one or some embodiments, the image processing system 1 may determine the size of the obstacle 19 in addition to (or instead of) one or both of the position or type of obstacle 19. The forefield 9 may extend laterally beyond the width of the attachment 22 so that obstacles 19 that are also located in the edge regions, in particular mobile obstacles such as people, animals or other agricultural working machines 2, may be detected.

Using the information provided by the image processing system 1, the regulation and control device 23 is configured to generate control signals that control an orientation of at least one of the light beams 27 that are emitted by the light sources 25 and assigned to the agricultural working machine 2 in order to orient the at least one bundled light beam 27 comprising (or consisting of) visible light toward the identified obstacle region 26 or the obstacle 19. To accomplish this, the regulation and control device 23 controls an actuator 30 of the at least one light source 25, by means of which the at least one light source 25 may be moved (e.g., may be pivoted about a vertical and/or a horizontal axis). Alternatively, or in addition, the regulation and control device 23 may send one or more signals to the at least one light source 25 in order to control at least one aspect of the beam generated by the at least one light source 25 (e.g., intensity, color, frequency, width, etc.).

The obstacle 19 or the obstacle region 26 may be specifically illuminated by the light beam 27 corresponding with the orientation of the at least one light source 25. In this way, the operator of the agricultural working machine 2 may be made immediately and directly aware of the obstacle 19 or obstacle region 26, which may be particularly advantageous when working in the dark or in difficult light conditions. Whereas in one exemplary case, the obstacle 19 shown on the right viewed in the driving direction 11 is a person who is standing in the crop, the obstacle 19 shown on the left is a rock or fawn that is covered by the crop so that the operator of the agricultural working machine 2 himself/herself cannot perceive this rock or fawn, or cannot perceive it in a timely manner. By the image processing system 1 evaluating the type of obstacle 19, either the obstacle 19 itself can be illuminated and/or the obstacle region 26, as in the exemplary case of the rock as an obstacle 19 that is not directly visible to the operator in the exemplary case. In both cases, the operator of the agricultural working machine 2 may be made aware of one or more existing obstacles 19 in the forefield of the agricultural working machine 2.

In so doing, the regulation and control device 23 is configured to track the orientation of the at least one light source 25, or respectively the light beam 27, when the agricultural working machine 2 approaches the obstacle region 26. As the distance to the identified obstacle region 26 decreases, the horizontal and/or vertical orientation of the at least one light source 25 that is oriented toward the obstacle 19 may be adapted in order to illuminate the obstacle 19 or the obstacle region 26 until it has been passed. For example, the beam generated by the at least one light source may be moved as the agricultural working machine 2 moves so that the beam maintains illumination of the obstacle 19 and/or the obstacle region 26.

Moreover, the regulation and control device 23 may be configured to control the at least one light source 25 in order to change at least one parameter of the at least one light beam 27 emitted by the light source 25 depending on the identified obstacle 19. In this way, the operator may more easily differentiate between living and inanimate obstacles 19. Furthermore, when working in the dark while the work lighting system is turned on, this may improve distinguishing between the work lighting system directed toward a work area and the at least one light beam 27 emitted by the light source 25 that is oriented toward an obstacle 19 and/or obstacle region 26.

To differentiate the obstacle 19 and/or the obstacle region 26, various aspects of the light may be changed, including any one, any combination, or all of: light color; light intensity; frequency; width of light beam; etc. In particular, to accomplish this, the light color and/or light intensity may be a changeable parameter. Accordingly, the regulation and control device 23 may send control signals to the at least one light source 25 in order to generate different colors with which the identified the obstacle region 26 and/or the obstacle 19 is illuminated depending on the type of obstacle 19 and/or whether the obstacle 19 is living or inanimate. Also, the regulation and control device 23 may vary the light intensity depending on the type of the obstacle 19 and/or the predominating light conditions (e.g., responsive to receiving data input from an ambient light sensor (not shown), the regulation and control device 23 may send a control signal to the at least one light source 25 in order to increase or decrease the light intensity generated by the at least one light source 25).

As another changeable parameter, the frequency may be adapted with which the at least one light source 25 emits a light beam 27. Accordingly, for example, the regulation and control device 23 may send a control signal to the at least one light source 25 such that the particular identified obstacle region 26 may be intermittently illuminated (e.g., in a strobe-like fashion) in order to highlight to the operator of the appearance of an obstacle 19.

Moreover, the regulation and control device 23 is configured to control the at least one light source 25 in order to adapt the light propagation of the light beam 27 emitted by the at least one light source 25. Accordingly, in one example, the light beam may comprise a divergent light beam that propagates as a conical light beam 27 or light bundle with a cross-section that increases as the distance from the light source increases. In one or some embodiments, the at least one light source may be controlled such that the light beam 27 may be varied. In one particular example, the emitted light beam 27 may be increasingly focused (e.g., increasingly narrow the width of the emitted light beam 27) while increasingly approaching the obstacle 19 or the obstacle region 26. In this regard, the narrowness of the emitted light beam 27 may be correlated to a distance of the agricultural working machine 2 to the obstacle 19 (with the beam becoming more narrow as the agricultural working machine 2 comes closer to the obstacle 19). In so doing, in one or some embodiments, the focusing of the at least one light beam 27 or the light bundle is limited to the size of the obstacle 19 ascertained by the image processing system 1.

In addition, the regulation and control device 23 is configured to control the orientation of at least two light sources 25 in order to focus the light beams 27 emitted by the at least two light sources 25 on an identified obstacle region 26 or an obstacle 19. This may be warranted, for example, when the identified obstacle 19 is living (e.g., the identified obstacle 19 is a person or an animal).

An arrangement of other light sources 25 on the attachment 22 is also contemplated. In particular, a distal arrangement on the outer ends of the attachment 22 offers additional benefit in that lateral regions in the forefield 9 that basically extend perpendicular to the driving direction 11 may be oriented toward identified obstacles 19 or obstacle regions 26 by correspondingly controlling the light sources using the regulation and control device 23. Likewise, the at least one optical sensor apparatus 24 may be arranged or positioned on the agricultural working machine 2 and/or on the front of the attachment 22 accommodated by or attached to the agricultural working machine 2. Consequently, an arrangement of, for example, laser scanners 6 or cameras 4 may be provided or positioned on the attachment 22 through which obstacles 19 can be identified.

It is intended that the foregoing detailed description be understood as an illustration of selected forms that the invention can take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some or all of the steps in the disclosed method are performed using a computer so that the methodology is computer implemented. In such cases, the resulting physical properties model may be downloaded or saved to computer storage.

### LIST OF REFERENCE NUMBERS

1 Image processing system
2 Working machine
3 Image generating system
4 Camera
5 Radar sensor
6 Laser scanner
7 Image
8 Surrounding area
9 Forefield
10 Region of an attachment
11 Driving direction
12 Transmitted surrounding area images
13 Preprocessed surrounding area images
14 Segmented surrounding area images
15 Classified surrounding area images
16 Segment
17 Image analysis unit
18 Class
19 Obstacle
20 Image data set
21 Data output unit
22 Attachment
23 Regulation and control device
24 Optical sensor apparatus
25 Light source
26 Obstacle region
27 Light beam
28 Processor
29 Memory
30 Actuator
31 Image acquisition
32 Standardization of intensity
33 Color standardization
34 Region of interest
35 SLIC
36 Calculation of segment features
37 SVM
38 Post-processing
39 Processor
40 Memory

1. An agricultural working machine comprising:
at least one optical sensor apparatus configured to detect a surrounding area in a forefield of the agricultural working machine;
an image processing system configured to perform image analysis and to detect, based on the image analysis, occurrence of one or more obstacles in at least one obstacle region lying in the surrounding area in the forefield of the agricultural working machine;
a work lighting system comprising at least one light source, the at least one light source configured to generate at least one light beam; and
a regulation and control device configured to generate one or more control signals in order to control an orientation of the at least one light source in order to orient the at least one light beam toward the at least one obstacle region.

2. The agricultural working machine of claim 1, wherein the regulation and control device is configured to modify the orientation of the at least one light beam of the at least one light source based on position of the agricultural working machine as the agricultural working machine approaches the at least one obstacle region in order to maintain the at least one light beam on the at least one obstacle region.

3. The agricultural working machine of claim 1, wherein the image processing system is configured to differentiate between different types of obstacles.

4. The agricultural working machine of claim 3, wherein the image processing system is configured to differentiate between living obstacles and inanimate obstacles; and
wherein the regulation and control device is configured to control the at least one light source in order to change at least one parameter of the at least one light beam depending on whether the obstacle is identified as a living obstacle or an inanimate obstacle.

5. The agricultural working machine of claim 4, wherein the at least one parameter comprises light color.

6. The agricultural working machine of claim 4, wherein the at least one parameter comprises light intensity.

7. The agricultural working machine of claim 4, wherein the at least one parameter comprises both light intensity and color.

8. The agricultural working machine of claim 4, wherein the at least one parameter comprises frequency; and
wherein the regulation and control device is configured to control the at least one light source in order to change the frequency of the at least one emitted light beam depending on whether the obstacle is identified as the living obstacle or the inanimate obstacle.

9. The agricultural working machine of claim 4, wherein the image processing system is configured to detect a first object in the forefield as the living obstacle and a second object in the forefield as the inanimate obstacle;
wherein the work lighting system comprising at least a first light source and a second light source; and
wherein the regulation and control device is configured to control the at least one parameter of a first beam from the first light source and a second beam of the second light source so that the first beam lights the living obstacle at least partly simultaneously as the second beam lights the inanimate obstacle and so that the first beam lights the living obstacle differently than the second beam lights the inanimate obstacle.

10. The agricultural working machine of claim 1, wherein the regulation and control device, responsive to the detection of the occurrence of one or more obstacles in at least one obstacle region, is configured to control at least one aspect of the at least one light source in order to adapt light propagation of the at least one light beam emitted by the at least one light source.

11. The agricultural working machine of claim 10, wherein the at least one aspect of the at least one light source comprises width of a beam generated by the at least one light source.

12. The agricultural working machine of claim 11, wherein the regulation and control device is configured to select the width of the beam based on a size of the one or more obstacles detected.

13. The agricultural working machine of claim 12, wherein the regulation and control device is configured to reduce the width of the beam from a larger size to the selected width as the agricultural working machine approaches the one or more obstacles detected.

14. The agricultural working machine of claim 1, wherein the regulation and control device, responsive to the detection of the occurrence of one or more obstacles in at least one obstacle region, is configured to control a light beam generated by the at least one light source in order to reduce a width of the beam as the agricultural working machine approaches the one or more obstacles detected.

15. The agricultural working machine of claim 1, wherein the at least one optical sensor apparatus is configured to detect the surrounding area in the forefield with light in an invisible range.

16. The agricultural working machine of claim 15, wherein the at least one optical sensor apparatus is designed as a laser scanner, lidar sensor, radar sensor or camera.

17. The agricultural working machine of claim 1, wherein the at least one light source is positioned on at least one of the agricultural working machine or on a front of an attachment to the agricultural working machine.

18. The agricultural working machine of claim 1, wherein the at least one optical sensor apparatus is positioned on at least one of the agricultural working machine or on a front of an attachment to the agricultural working machine.

19. The agricultural working machine of claim 1, wherein the regulation and control device is configured to control the orientation of at least two light sources in order to focus respective beams from the at least two light sources on the at least one obstacle region detected.

20. The agricultural working machine of claim 1, where the agricultural working machine comprises a self-propelling harvesting machine or a tractor.
